(19) United States
(12) Patent Application Publication
(10) Pub. No.: US 2010/0176786 A1
(43) Pub. Date: Jul. 15, 2010

(54) CONSTANT CURRENT CIRCUIT

(75) Inventor: Kouji YOKOSAWA, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/685,972

(22) Filed: Jan. 12, 2010

(30) Foreign Application Priority Data
Jan. 15, 2009 (JP) 2009-006927

(51) Int. Cl. G05F 1/10

(52) U.S. Cl. 323/349

(57) ABSTRACT

A constant current circuit in which the gradient of the temperature characteristic of a constant current which is output by the circuit includes a current source (11); a diode-connected N-channel MOS transistor (M1) having the current source connected to a drain thereof; a resistance element (RA1) connected between a source of the N-channel MOS transistor (M1) and ground and having a first temperature coefficient; an N-channel MOS transistor (M2) having a gate connected to a gate of the N-channel MOS transistor M1; and a resistance element (RA2), which has the first temperature coefficient, and a resistance element (RB2), which has a second temperature coefficient, connected between a source of the N-channel MOS transistor (M2) and ground; wherein the drain of the N-channel MOS transistor (M2) serves as an output terminal (12).

### REFERENCE TO RELATED APPLICATION

This application is based upon and claims the benefit of the priority of Japanese patent application No. 2009-006927, filed on Jan. 15, 2009, the disclosure of which is incorporated herein in its entirety by reference thereto.

### TECHNICAL FIELD

This invention relates to a constant current circuit and, more particularly, to a technique for controlling the temperature characteristic of output current.

### BACKGROUND

Constant current circuits are used widely in integrated circuits and the like. Such a constant current circuit requires that the output current have little temperature dependence and is constructed by combining resistance elements having different temperature coefficients. For example, a constant current circuit disclosed in Patent Document 1 is one which applies constant voltage to resistors and outputs the current that flows through the resistors and is so adapted that temperature coefficients are cancelled out by serially connecting a resistor having a positive temperature coefficient and a resistor having a negative temperature coefficient as the resistors.

Further, Patent Document 2 describes a constant current source circuit for realizing a flat temperature characteristic reliably irrespective of the magnitude or polarity of temperature coefficients of resistors.

### [Patent Document 1]

Japanese Patent Kokai Publication No. JP-A-02-66613

### [Patent Document 2]

Japanese Patent Kokai Publication No. JP-P2005-316530A

### SUMMARY

The entire disclosures of Patent Documents 1 and 2 are incorporated herein by reference thereto.

The analysis set forth below is given in the present invention.

The object of the examples of the conventional art is to cancel the temperature characteristic of a constant current output. Depending upon the circuit, such as a temperature sensor, there are cases where a temperature characteristic having a larger slope is advantageous. However, since the constant current circuits of the conventional art are adapted for the purpose of achieving a flat temperature characteristic in terms of the output current, the slope of the temperature characteristic of the output constant current cannot be set over a wide range and hence the circuits cannot be applied as is to a circuit such as a temperature sensor.

According to a first aspect of the present invention, there is provided a constant current circuit. The constant current circuit comprises: a current source; a diode-connected first first-conductivity-type transistor having the current source connected to a drain thereof; a first resistance element connected between a source of the first first-conductivity-type transistor and ground and having a first temperature coefficient; a second first first-conductivity-type transistor having a gate connected to a gate of the first first-conductivity-type transistor; and a second resistance element connected between a source of the second first-conductivity-type transistor and ground and having a second temperature coefficient. A drain of the second first-conductivity-type transistor serves as a current output terminal.

The meritorious effects of the present invention are summarized as follows.

In accordance with the present invention, the slope of the temperature characteristic of output constant current can be set over a wide range by resistance elements having different temperature coefficients.

Other features and advantages of the present invention will be apparent from the following description taken in conjunction with the accompanying drawings, in which like reference characters designate the same or similar parts throughout the figures thereof.

### BRIEF DESCRIPTIONS OF THE DRAWINGS

FIG. 1 is a circuit diagram of a constant current circuit according to a first exemplary embodiment of the present invention;

FIG. 2 is a diagram illustrating temperature characteristics of output current in a case where values of resistance elements of the constant current circuit are changed;

FIG. 3 is a circuit diagram of a constant current circuit according to a second exemplary embodiment of the present invention; and

FIG. 4 is a circuit diagram of a constant current circuit according to a third exemplary embodiment of the present invention.

### PREFERRED MODES

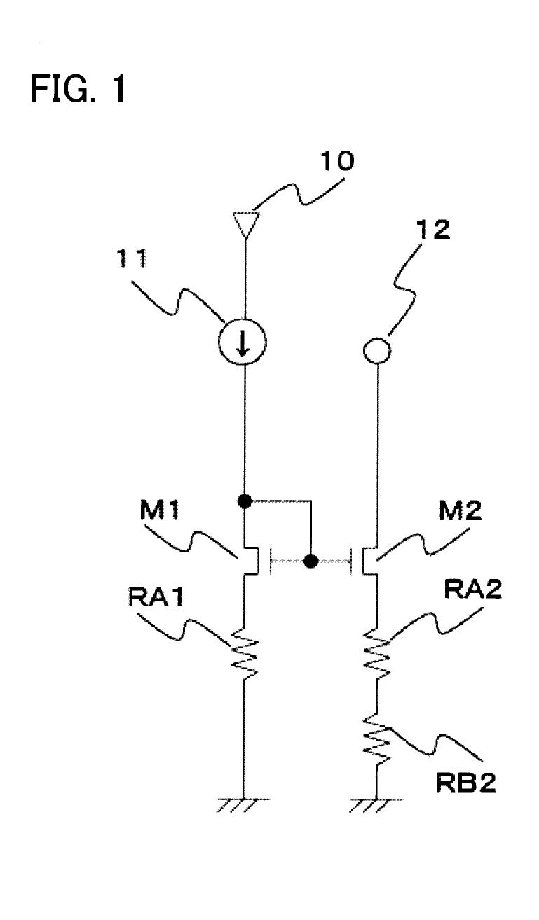

A constant current circuit according to a mode of the present invention comprises a current source (11 in FIG. 1); a diode-connected first first-conductivity-type transistor (M1 in FIG. 1) having the current source connected to a drain thereof; a first resistance element (RA1 in FIG. 1) connected between a source of the first first-conductivity-type transistor and ground and having a first temperature coefficient; a second first first-conductivity-type transistor (M2 in FIG. 1) having a gate connected to a gate of the first first-conductivity-type transistor; and a second resistance element (RB2 in FIG. 1) connected between a source of the second first-conductivity-type transistor and ground and having a second temperature coefficient. A drain of the second first-conductivity-type transistor serves as a current output terminal (12 in FIG. 1).

The constant current circuit may further comprise a third resistance element (RA2 in FIG. 1) connected in series with the second resistance element between the source of the second first-conductivity-type transistor and ground and having the first temperature coefficient.

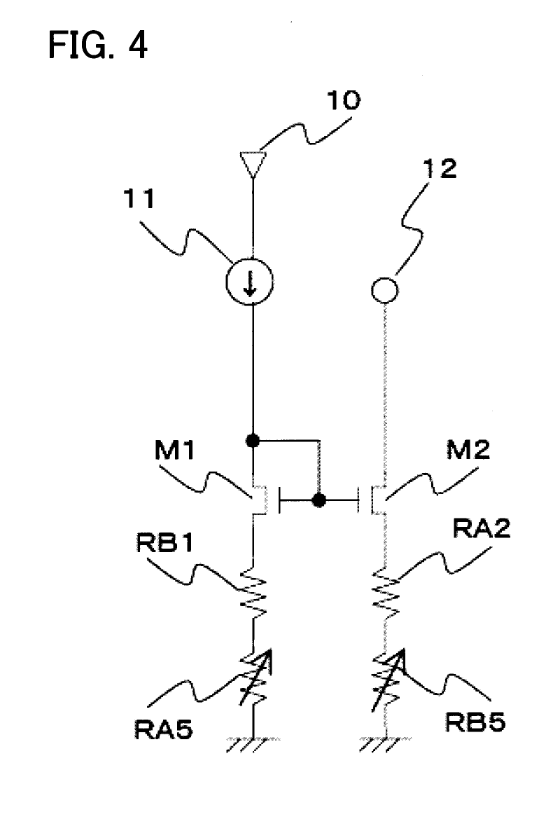

The constant current circuit may further comprise a fourth resistance element (RB1 in FIG. 4) connected in series with the first resistance element between the source of the first first-conductivity-type transistor and ground and having the second temperature coefficient.

The first and second resistance elements in the constant current circuit may be variable resistance elements (RA5, RB5 in FIG. 4).

Resistance elements having temperature coefficients that differ from each other may be connected between the source of the second first-conductivity-type transistor and ground in parallel or serially.

Resistance elements having temperature coefficients that differ from each other may be connected between the source of the first first-conductivity-type transistor and ground in parallel or serially.

Resistance elements having temperature coefficients that differ from each other may be connected between the source of the second first-conductivity-type transistor and ground in a serial-parallel combination.

Resistance elements having temperature coefficients that differ from each other may be connected between the source of the first first-conductivity-type transistor and ground in a serial-parallel combination.

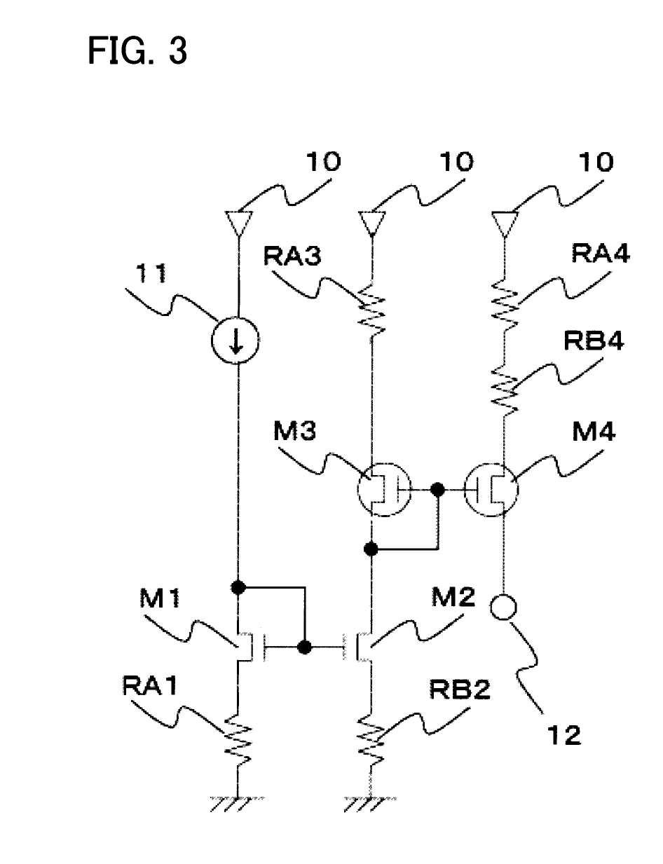

The constant current circuit may further comprise a diode-connected first second-conductivity-type transistor (M3 in FIG. 1) having a drain connected to the current output terminal; a fifth resistance element (RA3 in FIG. 3) connected between the source of the first second-conductivity-type transistor and a power source and having the first temperature coefficient; a second second-conductivity-type transistor (M4 in FIG. 3) having a gate connected to the gate of the first second-conductivity-type transistor; and a sixth resistance element (RB4 in FIG. 3) connected between the source of the second second-conductivity-type transistor and the power source and having the second temperature coefficient. The drain of the second second-conductivity-type transistor serves as another current output terminal (12 in FIG. 3).

In accordance with such a semiconductor device, it is so arranged that the temperature coefficients of the resistance elements are made different from each other. As a result, owing to a difference between the temperature characteristic of the input current and the temperature characteristic of the output current, it is possible to set an output current the temperature characteristic of which has a positive or negative characteristic, as desired, even in a semiconductor process the polarity of which is only positive or only negative.

Note the symbols attached hereinabove to the elements presented in the parentheses in the preferred modes are exclusively for better understanding and should not be construed as limiting nature.

Exemplary embodiments of the present invention will now be described in detail with reference to the drawings.

### FIRST EXEMPLARY EMBODIMENT

FIG. 1 is a circuit diagram of a constant current circuit according to a first exemplary embodiment of the present invention. The constant current circuit in FIG. 1 includes a current source 11, N-channel MOS transistors M1, M2 and resistance elements RA1, RA2, RB2.

The current source 11 has one terminal connected to a power source 10 and another terminal connected to the gate and drain of the N-channel MOS transistor M1. The resistance element RA1, which has a first temperature coefficient, is connected between the source of the N-channel MOS transistor M1 and ground. The N-channel MOS transistor M2 has a gate connected in common with the gate of the N-channel MOS transistor M1. The resistance element RA2, which has the first temperature coefficient, and the resistance element RB2, which has a second temperature coefficient, are serially connected between the source of the N-channel MOS transistor M2 and ground, and drain current is output to an output terminal 12 from the drain of the N-channel MOS transistor M2.

The N-channel MOS transistors M1 and M2 construct a current mirror. Since the temperature coefficient of the resistance element R1 and the temperature coefficient of the resistance that is the result of combining the resistance elements RA2 and RB2 differ, the difference in potential between the source potential of the N-channel MOS transistor M1 and the source potential of the N-channel MOS transistor M2 differs depending upon the temperature. As a consequence, the difference between a gate-source voltage Vgs1 of the N-channel MOS transistor M1 and a gate-source voltage Vgs2 of the N-channel MOS transistor M2 also differs depending upon the temperature. Accordingly, a temperature characteristic of the current that flows into the N-channel MOS transistor M1 from the current source 11 and a temperature characteristic of the current that is output from the drain of the N-channel MOS transistor M2 are different from one another. In this case, the gradient of the temperature characteristic of the output current is capable of being set to a positive or negative slope at will depending upon the ratio of the resistance value of RA2 to the resistance value of RB2.

The resistance value may be set in such a manner that the voltage across the resistance element RA1 produced by the current that flows from the current source 11 via the N-channel MOS transistor M1 will be 50 to 100 mV or greater, for instance. That is, the resistance value may be set in such a manner that the voltage will be sufficiently large with respect to ΔVt of the MOS transistor and a change ΔVgs in the gate voltage ascribable to a change ΔIds in the current that flows into the MOS transistor.

If it is so arranged that the N-channel MOS transistors M1, M2 take on a sufficiently large gm with respect to the current that flows from the current source 11, then there will be almost no change in the difference between the gate-source voltage Vgs1 of the N-channel MOS transistor M1 and the gate-source voltage Vgs2 of the N-channel MOS transistor M2 even if the current on the output side changes somewhat.

Accordingly, if the dimensions of the N-channel MOS transistors M1 and M2 are made the same and the resistance values are set as indicated by Equation (1) below, then the currents that flow into the N-channel MOS transistors M1 and M2 will be approximately identical.

RA1 resistance value≈RA2 resistance value+RB2 resistance value (1)

In this case, Equation (2) below holds.

source potential of N-channel MOS transistor M1≈source potential of N-channel MOS transistor M2 (2)

Further, Equations (3) and (4) below hold.

source potential of N-channel MOS transistor M1≈current source 11 current*(R1a*(1+dta*(T−25))) (3)

source potential of N-channel MOS transistor M2≈output current*(R2a*(1+dta*(T−25))+R2b*(1+dtb*(T−25))) (4)

The following equation is obtained from Equations (2), (3) and (4) cited above:

output current≈(current source 11 current*(R1a*(1+dta*(T−25))))/(R2a*(1+dta*(T−25))+R2b*(1+dtb*(T−25))) (5)

where R1a: resistance value of RA1 at 25° C.;

Ra2: resistance value of RA2 at 25° C.;

R2b: resistance value of RB2 at 25° C.;

dta: temperature coefficient of resistance possessed by RA1, RA2; and

dtb: temperature coefficient of resistance possessed by RB2.

In Equation (5), the difference in temperature characteristic of the output current is smallest when RA2=RA1, RB2=0 Ω holds. In this case, the output current becomes the same as the current of the current source 11 inclusive of the temperature characteristic, as indicated by Equation (6) below.

output current≈(current source 11 current*(R1a*(1+dta*(T−25))))/(R2a*(1+dta*(T−25)))≈current of current source 11 (6)

Conversely, the difference in temperature characteristic of the output current in Equation (5) is largest when RA2=0 Ω, RB2=RA1 holds. In this case, the output current becomes as indicated by Equation (7) below.

output current≈(current source 11 current*(R1a*(1+dta*(T−25))))/(R2b*(1+dtb*(T−25)))≈current source 11 current*((1+dta*(T 25))/(1+dtb*(T−25))) (7)

In view of Equation (7), if there is a difference between the temperature coefficient dta of the resistance of RA1 and RA2 and the temperature coefficient dtb of the resistance of RB2, then, in case of dta>dtb, the higher the temperature becomes, the larger the output current and the temperature characteristic will have a positive gradient. Conversely, in case of dta<dtb, the higher the temperature becomes, the smaller the output current and the temperature characteristic will have a negative gradient.

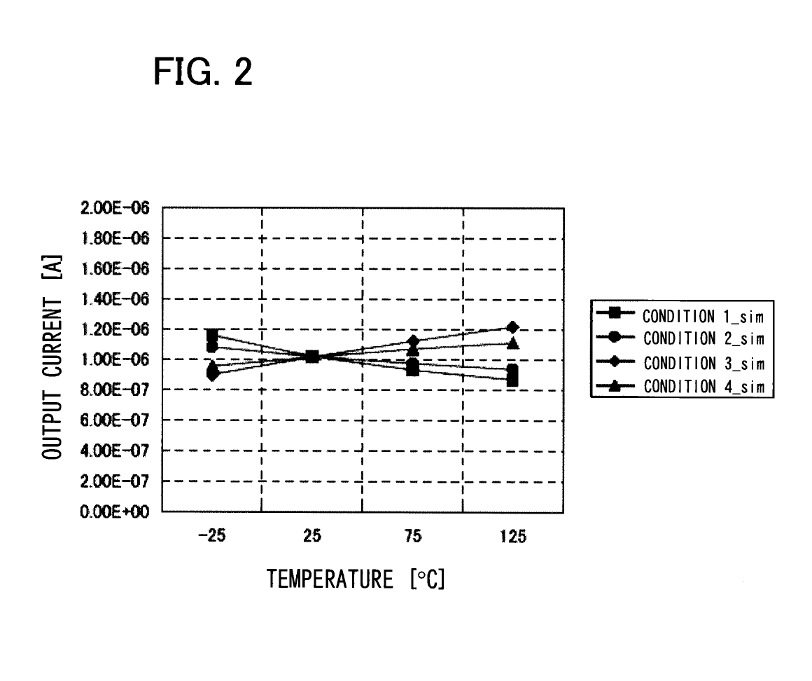

FIG. 2 is a diagram illustrating temperature characteristics of output current in a case where the values of the resistance elements of the constant current circuit are set as indicated below.

Condition 1: RA1=100 KΩ (0.1 [%/K]), RB2=100 KΩ (0.4 [%/K])

Condition 2: RA1=100 KΩ (0.1 [%/K]), RA2=50 KΩ (0.1 [%/K]), RB2=50 KΩ (0.4 [%/K])

Condition 3: RA1=100 KΩ (0.4 [%/K]), RB2=100 KΩ (0.1 [%/K])

Condition 4: RA1=100 KΩ (0.4 [%/K]), RA2=50 KΩ (0.4 [%/K]), RB2=50 KΩ (0.1 [%/K])

Thus, as described above, the gradient of the temperature characteristic of the output current can be set to be positive or negative at will by suitably setting the ratio of the resistance value of RA2 to the resistance value of RB2.

### SECOND EXEMPLARY EMBODIMENT

FIG. 3 is a circuit diagram of a constant current circuit according to a second exemplary embodiment of the present invention. Components in FIG. 3 identical with those shown in FIG. 1 are designated by like reference characters and need not be described again. The constant current circuit of the second exemplary embodiment includes a current mirror, which is constructed by a P-channel MOS transistor M3 and a P-channel MOS transistor M4, the input to which is the output current of the constant current circuit of FIG. 1. The constant current circuit further includes a resistance element RA3, which has the first temperature coefficient, provided between the source of the P-channel MOS transistor M3 and the power source 10. A resistance element RA4 having the first temperature coefficient and a resistance element RB4 having the second temperature coefficient are serially connected between the source of the P-channel MOS transistor M4 and the power source 10. The drain current of the P-channel MOS transistor M4 is output from the output terminal 12. It should be noted that the resistance element RA2 of FIG. 1 is omitted.

In the constant current circuit set forth above, the circuit comprising the P-channel MOS transistors M3, M4 and resistance elements RA3, RA4, RB4 has a different polarity but has the same circuit structure and operates in the same manner as the circuit of FIG. 1 comprising the N-channel MOS transistors M1, M2 and resistance elements RA1, RA2, RB2.

In accordance with the constant current circuit of the second exemplary embodiment, the gradient of the temperature characteristic of the output current obtained via the N-channel MOS transistors M1, M2 can be enlarged further via the P-channel MOS transistors M3, M4. Accordingly, it is possible for the slope of the temperature characteristic of the output current to be adjusted over a wider range.

### THIRD EXEMPLARY EMBODIMENT

FIG. 4 is a circuit diagram of a constant current circuit according to a third exemplary embodiment of the present invention. Components in FIG. 4 identical with those shown in FIG. 1 are designated by like reference characters and need not be described again. In the constant current circuit of the third exemplary embodiment, a resistance element RB1 having the second temperature coefficient and a variable resistance element RA5 having the first temperature coefficient are serially connected between the source of the N-channel MOS transistor M1 and ground of the first exemplary embodiment, the resistance element RA2 having the first temperature coefficient and a variable resistance element RB5 having the second temperature coefficient are serially connected between the source of the N-channel MOS transistor M2 and ground, and the drain current of the N-channel MOS transistor M2 is output from the output terminal 12.

Thus, this constant current circuit includes the variable resistance element RB5 having the second temperature coefficient and the variable resistance element RA5 having the first temperature coefficient. Accordingly, in a case where the constant current circuit has been incorporated in a semiconductor integrated circuit, the resistance values of the variable resistance elements RA5 and RB5 are changed by a program of an external microcomputer (not shown) or the like, thereby making it possible to change the gradient of the temperature characteristic of the output current appropriately.

The disclosures of Patent Documents cited above are incorporated by reference in this specification. Within the bounds of the full disclosure of the present invention (inclusive of the claims), it is possible to modify and adjust the modes and exemplary embodiments of the invention based upon the fundamental technical idea of the invention. Multifarious combinations and selections of the various disclosed elements are possible within the scope of the claims of the present invention. That is, it goes without saying that the invention covers various modifications and changes that would be obvious to those skilled in the art within the scope of the claims.

What is claimed is:

1. A constant current circuit comprising:
a current source;
a diode-connected first first-conductivity-type transistor having the current source connected to a drain thereof;
a first resistance element connected between a source of said first first-conductivity-type transistor and ground and having a first temperature coefficient;
a second first first-conductivity-type transistor having a gate connected to a gate of said first first-conductivity-type transistor; and
a second resistance element connected between a source of said second first-conductivity-type transistor and ground and having a second temperature coefficient;
wherein a drain of said second first-conductivity-type transistor serves as a current output terminal.

2. The circuit according to claim 1, further comprising a third resistance element connected in series with said second resistance element between the source of said second first-conductivity-type transistor and ground and having the first temperature coefficient.

3. The circuit according to claim 1, further comprising a fourth resistance element connected in series with said first resistance element between the source of said first first-conductivity-type transistor and ground and having the second temperature coefficient.

4. The circuit according to claim 1, wherein said first and second resistance elements are variable resistance elements.

5. The circuit according to claim 1, wherein resistance elements having temperature coefficients that differ from each other are connected between the source of said second first-conductivity-type transistor and ground in parallel or serially.

6. The circuit according to claim 1, wherein resistance elements having temperature coefficients that differ from each other are connected between the source of said first first-conductivity-type transistor and ground in parallel or serially.

7. The circuit according to claim 1, wherein resistance elements having temperature coefficients that differ from each other are connected between the source of said second first-conductivity-type transistor and ground in a serial-parallel combination.

8. The circuit according to claim 1, wherein resistance elements having temperature coefficients that differ from each other are connected between the source of said first first-conductivity-type transistor and ground in a serial-parallel combination.

9. The circuit according to claim 1, further comprising:
a diode-connected first second-conductivity-type transistor having a drain connected to the current output terminal;
a fifth resistance element connected between the source of said first second-conductivity-type transistor and a power source and having the first temperature coefficient;
a second second-conductivity-type transistor having a gate connected to the gate of said first second-conductivity-type transistor; and
a sixth resistance element connected between the source of said second second-conductivity-type transistor and the power source and having the second temperature coefficient;
wherein a drain of said second second-conductivity-type transistor serves as another current output terminal.

10. A semiconductor integrated circuit device having the constant current circuit set forth in claim 1.

11. The circuit according to claim 2, further comprising a fourth resistance element connected in series with said first resistance element between the source of said first first-conductivity-type transistor and ground and having the second temperature coefficient.

12. The circuit according to claim 2, wherein said first and second resistance elements are variable resistance elements.

13. The circuit according to claim 3, wherein said first and second resistance elements are variable resistance elements.

14. The circuit according to claim 2, further comprising:
a diode-connected first second-conductivity-type transistor having a drain connected to the current output terminal;
a fifth resistance element connected between the source of said first second-conductivity-type transistor and a power source and having the first temperature coefficient;
a second second-conductivity-type transistor having a gate connected to the gate of said first second-conductivity-type transistor; and
a sixth resistance element connected between the source of said second second-conductivity-type transistor and the power source and having the second temperature coefficient;
wherein a drain of said second second-conductivity-type transistor serves as another current output terminal.

15. The circuit according to claim 3, further comprising:
a diode-connected first second-conductivity-type transistor having a drain connected to the current output terminal;
a fifth resistance element connected between the source of said first second-conductivity-type transistor and a power source and having the first temperature coefficient;
a second second-conductivity-type transistor having a gate connected to the gate of said first second-conductivity-type transistor; and
a sixth resistance element connected between the source of said second second-conductivity-type transistor and the power source and having the second temperature coefficient;
wherein a drain of said second second-conductivity-type transistor serves as another current output terminal.

16. The circuit according to claim 4, further comprising:
a diode-connected first second-conductivity-type transistor having a drain connected to the current output terminal;
a fifth resistance element connected between the source of said first second-conductivity-type transistor and a power source and having the first temperature coefficient;
a second second-conductivity-type transistor having a gate connected to the gate of said first second-conductivity-type transistor; and
a sixth resistance element connected between the source of said second second-conductivity-type transistor and the power source and having the second temperature coefficient;
wherein a drain of said second second-conductivity-type transistor serves as another current output terminal.

17. A semiconductor integrated circuit device having the constant current circuit set forth in claim 2.

18. A semiconductor integrated circuit device having the constant current circuit set forth in claim 3.

19. A semiconductor integrated circuit device having the constant current circuit set forth in claim 4.

20. A semiconductor integrated circuit device having the constant current circuit set forth in claim 9.
